(19) United States
(12) Patent Application Publication
(10) Pub. No.: US 2025/0229528 A1
(43) Pub. Date: Jul. 17, 2025

(54) LIQUID EJECTION HEAD, LIQUID EJECTION APPARATUS, AND METHOD OF MANUFACTURING LIQUID EJECTION HEAD

(71) Applicant: CANON KABUSHIKI KAISHA, Tokyo (JP)

(72) Inventor: KEISUKE KISHIMOTO, Kanagawa (JP)

(21) Appl. No.: 19/001,824

(22) Filed: Dec. 26, 2024

(30) Foreign Application Priority Data
Jan. 16, 2024 (JP) 2024-004720

(51) Int. Cl. B41J 2/14; B41J 2/16; B41J 2/18

(52) U.S. Cl. CPC B41J 2/14145; B41J 2/1601; B41J 2/1623; B41J 2/1629; B41J 2/18; B41J 2002/14419

(57) ABSTRACT

Provided are a liquid ejection head, a liquid ejection apparatus, a method of manufacturing a liquid ejection head in which an element substrate and a support member differing in the pitches between liquid supply ports are fluidly connected by a channel member. To that end, supply paths in the element substrate and resin supply paths in the support member are connected by channels formed in the channel member and including expanding portions.

### BACKGROUND

### Field

The present disclosure relates to a liquid ejection head, a liquid ejection apparatus, and a method of manufacturing a liquid ejection head.

### Description of the Related Art

In recent years, various silicon devices have been employed in devices such as inkjet print heads. A microfabrication technique that is a micromachining technique is used to manufacture such silicon devices.

Japanese Patent Laid-Open No. 2004-148824 discloses an inkjet print head in which an element substrate including channels with multiple ejection energy generation elements disposed therein, ejection ports for ejecting an ink, and supply ports for supplying the liquid to the ejection ports is bonded to and held on a support member including ink supply paths.

In a configuration as disclosed in Japanese Patent Laid-Open No. 2004-148824, the pitches between the supply ports in the element substrate may sometimes be made narrow in order to provide a small and high-definition liquid ejection head. In that case, it is generally difficult to narrow the pitches between the ink supply paths in the support member, which are to be connected to the supply ports in the element substrate, to match the pitches between the supply ports in the element substrate. For this reason, a channel member for changing pitches is interposed between the element substrate and the support member to connect the supply ports in the element substrate and the supply paths in the support member by channels provided in the channel member.

The channel member is generally made by laminating multiple members formed by injection molding. Here, in the case of forming the channel member by injection molding, the thickness of the resin wall between channels can be generally reduced to a thickness of about 0.5 mm at most. Thus, it is difficult to further narrow the pitches between the channels in the channel member obtained by laminating multiple members formed by injection molding, which is a conventional method, to pitches corresponding the narrow pitches between the supply ports in the element substrate.

Also, the lamination of multiple members to form the channel member increases the number of components, which tends to increase the cost.

### SUMMARY

In view of the above, the present disclosure provides a liquid ejection head, a liquid ejection apparatus, a method of manufacturing a liquid ejection head in which an element substrate and a support member differing in the pitches between liquid supply ports are fluidly connected by a channel member.

A liquid ejection head of the present disclosure is a liquid ejection head including: an ejection substrate including a first ejection port array being a plurality of ejection ports for ejecting a liquid arranged in an array, and a first supply path for supplying the liquid to the first ejection port array; a channel member including a first channel that communicates with the first supply path in a case where the channel member is laminated on the ejection substrate; and a support member including a first support member supply path that communicates with the first channel in a case where the support member is laminated on a second surface of the channel member on an opposite side from a first surface thereof on which the ejection substrate is laminated. The first channel includes: a first penetrating portion penetrating through the channel member in a direction of the lamination; a first expanding portion partly facing a first opening of the first supply path, having a depth in the direction of the lamination, and extending in a first direction from a position opposed to the first opening to the first penetrating portion; and a second expanding portion partly facing a second opening of the first support member supply path, having a depth in the direction of the lamination, and extending in the first direction from the first penetrating portion to the second opening so as to have an opening area larger than an opening area of the first expanding portion.

According to the present disclosure, it is possible to provide a liquid ejection head, a liquid ejection apparatus, a method of manufacturing a liquid ejection head in which an element substrate and a support member differing in the pitches between liquid supply ports are fluidly connected by a channel member.

Further features of the present disclosure will become apparent from the following description of exemplary embodiments with reference to the attached drawings.

### BRIEF DESCRIPTION OF THE DRAWINGS

FIG. 1 is an enlarged view of a liquid ejection head of a liquid ejection apparatus and its surroundings;

FIGS. 2A and 2B are perspective views illustrating the liquid ejection head and an ejection unit;

FIG. 3 is a schematic external view of a circulation unit;

FIG. 4 is a vertical cross-sectional view schematically illustrating a circulation path;

FIG. 5 is a block diagram schematically illustrating the circulation path;

FIGS. 6A and 6B are cross-sectional views taken along the VI-VI line in FIG. 2B; and

FIGS. 7A to 7E are views illustrating a process of manufacturing a channel member in the order of steps.

### DESCRIPTION OF THE EMBODIMENTS

An embodiment of the present disclosure will be described below with reference to the drawings.

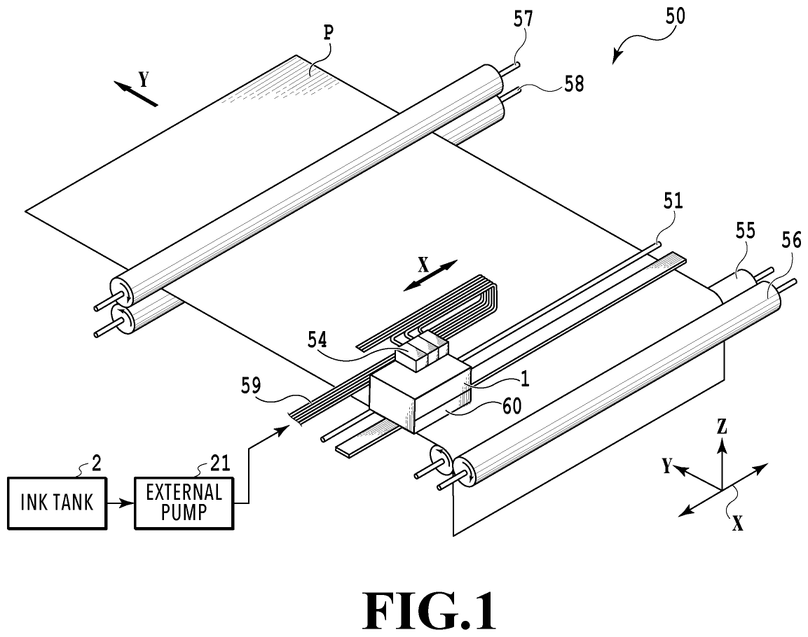

FIG. 1 is a view for describing a liquid ejection apparatus, and is an enlarged view of a liquid ejection head 1 of a liquid ejection apparatus 50 and its surroundings. First, a schematic configuration of the liquid ejection apparatus 50 in the present embodiment will be described with reference to FIG. 1. FIG. 1 is a perspective view schematically illustrating the liquid ejection apparatus 50 using the liquid ejection head 1. The liquid ejection apparatus 50 in the present embodiment is configured as a serial inkjet printing apparatus that performs printing on a print medium P by ejecting inks as liquids while scanning the liquid ejection head 1.

The liquid ejection head 1 is mounted on a carriage 60. The carriage 60 reciprocally moves in a main scanning direction (X direction) along a guide shaft 51. The print medium P is conveyed in a sub scanning direction (Y direction) crossing (in this example, orthogonally crossing) the main scanning direction by conveyance rollers 55, 56, 57, and 58. In sum, the liquid ejection head 1 is configured to eject inks while being scanned in a direction orthogonal to the conveyance direction of a print medium to which the liquids are to be applied. Note that, in drawings to be referred to below, the Z direction represents a vertical direction and crosses (in this example, orthogonally crosses) an X-Y plane defined by the X direction and the Y direction. The liquid ejection head 1 is configured to be attachable to and detachable from the carriage 60 by a user.

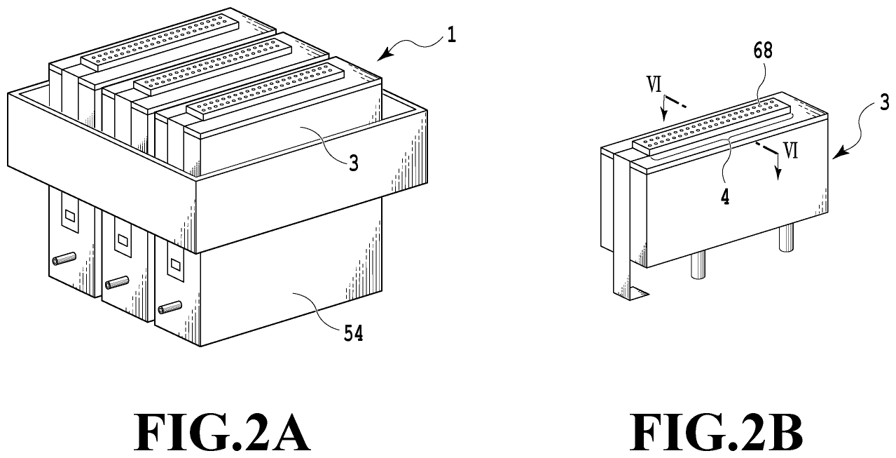

The liquid ejection head 1 includes circulation units 54 and later-described ejection units 3 (see FIG. 2A). While a specific configuration will be described later, the ejection units 3 are provided with multiple ejection ports and energy generation elements (hereinafter referred to as “ejection elements”) that generate ejection energy for ejecting the liquids from the ejection ports.

Also, the liquid ejection apparatus 50 is provided with ink tanks 2 (liquid storage units) as ink supply sources and external pumps 21, and the inks stored in the ink tanks 2 are supplied to the circulation units 54 through ink supply tubes 59 by driving forces of the external pumps 21.

The liquid ejection apparatus 50 forms a predetermined image on the print medium P by repeating a printing scan involving performing printing by causing the liquid ejection head 1 mounted (mountable) on the carriage 60 to eject the inks while moving in the main scanning direction, and a conveyance operation involving conveying the print medium P in the sub scanning direction. Note that the liquid ejection head 1 in the present embodiment is configured to be capable of ejecting three types of inks. However, the configuration of the inkjet printing apparatus in the present disclosure is not limited to one that ejects three types of liquids.

Examples include a configuration capable of ejecting black (K), cyan (C), magenta (M), yellow (Y), and white (W) inks. In this case, full-color images can be printed with these inks. The present disclosure is also applicable to liquid ejection heads for ejecting other types of inks and liquids other than inks, such as reaction liquids. In short, the types and number of liquids to be ejected from the liquid ejection head are not limited.

Also, in the liquid ejection apparatus 50, a cap member (not illustrated) capable of covering the ejection port surface of the liquid ejection head in which its ejection ports are formed is provided at a position separated from the conveyance path for the print medium P in the X direction. The cap member covers the ejection port surface of the liquid ejection head 1 during a non-print operation, and is used for prevention of drying of the ejection ports, protection of the ejection ports, an ink suction operation from the ejection ports, and so on.

Note that the liquid ejection head 1 illustrated in FIG. 1 represents an example where three circulation units 54 corresponding to the three types of inks are included in the liquid ejection head 1, but it suffices that the circulation units 54 included correspond to the types of liquids to be ejected. Also, multiple circulation units 54 may be included for the same type of liquid. In sum, the liquid ejection head 1 can have a configuration including one or more circulation units. The liquid ejection head 1 may be configured not to circulate all of the three types of inks but only circulate at least one of the inks. Note that the present disclosure is applicable even to a configuration in which the liquid ejection head 1 does not include the circulation units 54.

FIG. 2A is a perspective view illustrating the liquid ejection head 1 to which the present disclosure is applicable, and FIG. 2B is a perspective view illustrating an ejection unit 3. The liquid ejection head 1 according to the present embodiment includes three ejection units 3 and three circulation units 54. The ejection units 3 eject the liquids circulated by the circulation units 54 from ejection ports 68. Multiple ejection ports 68 are provided and arrayed to form ejection port arrays 4.

### Constituent Elements of Circulation Units

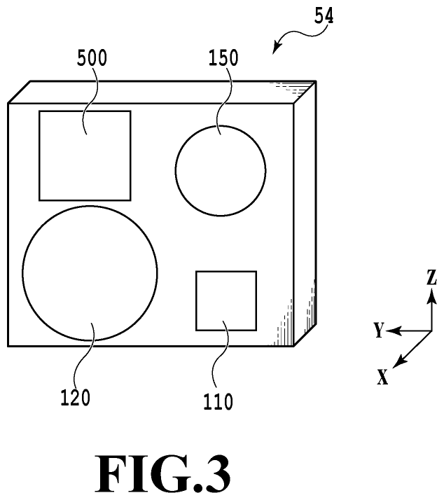

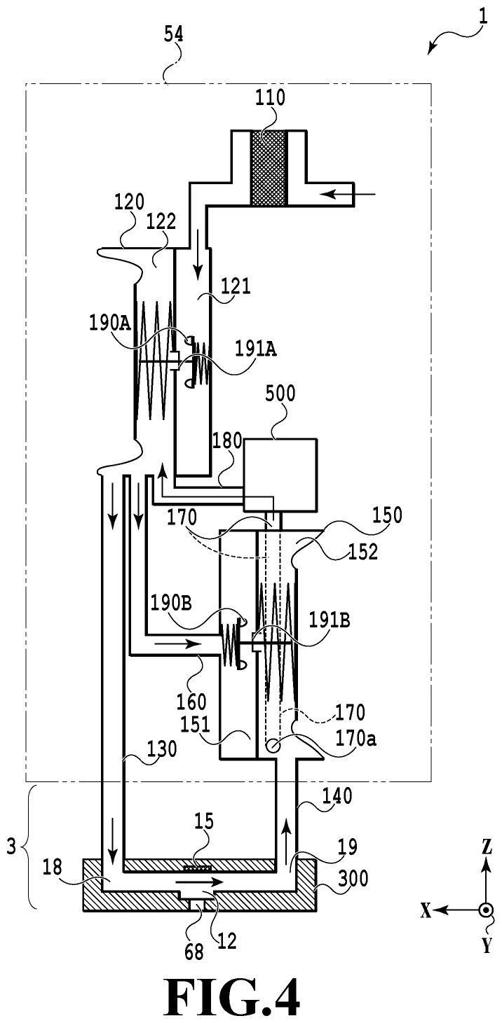

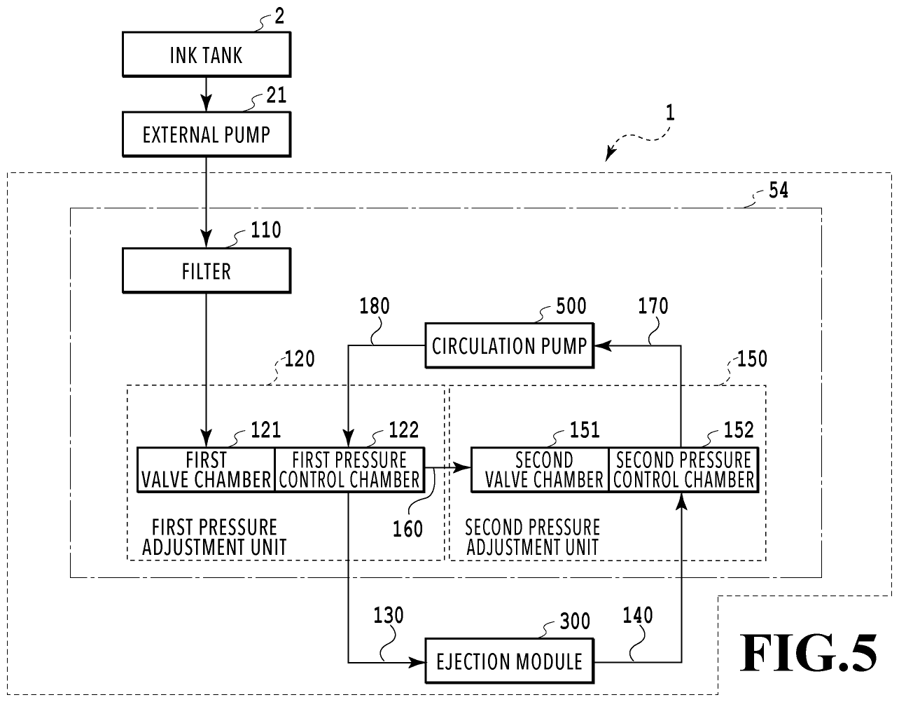

FIG. 3 is a schematic external view of one circulation unit 54 for one type of ink used in the printing apparatus in the present embodiment. The circulation unit 54 desirably has a filter 110, a first pressure adjustment unit 120, and a second pressure adjustment unit 150 as well as a circulation pump 500. These constituent elements are connected by channels as illustrated in FIGS. 4 and 5 to be mentioned later to thereby form a circulation path for supplying and collecting the ink to and from an ejection module 300 inside the liquid ejection head 1.

### Circulation Path Inside Liquid Ejection Head

FIG. 4 is a vertical cross-sectional view schematically illustrating the circulation path for one type of ink (ink of one color) formed inside the liquid ejection head 1. The relative positions of the components in FIG. 4 (such as the first pressure adjustment unit 120, the second pressure adjustment unit 150, and the circulation pump 500) are simplified for a clearer description of the circulation path. Thus, the relative positions of the components are different from those of the components in FIG. 19 to be mentioned later. Incidentally, FIG. 5 is a block diagram schematically illustrating the circulation path illustrated in FIG. 4. As illustrated in FIGS. 4 and 5, the first pressure adjustment unit 120 includes a first valve chamber 121 and a first pressure control chamber 122. The second pressure adjustment unit 150 includes a second valve chamber 151 and a second pressure control chamber 152. The first pressure adjustment unit 120 is configured such that the controlled pressure therein is higher than that in the second pressure adjustment unit 150.

In the present embodiment, these two pressure adjustment units 120 and 150 are used to implement circulation within a certain pressure range inside the circulation path. Also, the configuration is such that the ink flows through pressure chambers 12 (ejection elements 15) at a flow rate corresponding to the pressure difference between the first pressure adjustment unit 120 and the second pressure adjustment unit 150. A circulation path in the liquid ejection head 1 and a flow of the ink in the circulation path will be described below with reference to FIGS. 4 and 5. Note that the arrows in FIGS. 4 and 5 indicate the flow direction of the ink.

First, how the constituent elements in the liquid ejection head 1 are connected will be described.

The external pump 21, which sends the ink stored in the ink tank 2 (see FIG. 1) provided outside the liquid ejection head 1 to the liquid ejection head 1, is connected to the circulation unit 54 through the ink supply tube 59 (see FIG. 1). The ink channel (inflow channel) located on an upstream side of the circulation unit 54 is provided with the filter 110. The ink supply path (inflow channel) located downstream of the filter 110 is connected to the first valve chamber 121 of the first pressure adjustment unit 120. The first valve chamber 121 communicates with the first pressure control chamber 122 through a communication port 191A openable and closable by a valve 190A illustrated in FIG. 4. Note that the inflow channel is a channel through which the liquid in the ink tank 2 provided outside the liquid ejection head 1 flows into the liquid ejection head 1 to be supplied to the pressure chambers 12.

The first pressure control chamber 122 is connected to a supply channel 130, a bypass channel 160, and a pump outlet channel 180 of the circulation pump 500. The supply channel 130 is connected through an ink supply port provided in the ejection module 300 to a common supply channel 18. Also, the bypass channel 160 is connected to the second valve chamber 151 provided in the second pressure adjustment unit 150. The second valve chamber 151 communicates with the second pressure control chamber 152 through a communication port 191B that is opened and closed by a valve 190B illustrated in FIG. 4.

Note that FIGS. 4 and 5 illustrate an example where one end of the bypass channel 160 is connected to the first pressure control chamber 122 of the first pressure adjustment unit 120, and the other end of the bypass channel 160 is connected to the second valve chamber 151 of the second pressure adjustment unit 150. However, the one end of the bypass channel 160 may be connected to the supply channel 130, and the other end of the bypass channel may be connected to the second valve chamber 151.

The second pressure control chamber 152 is connected to a collection channel 140. The collection channel 140 is connected through an ink collection port provided in the ejection module 300 to a common collection channel 19. Moreover, the second pressure control chamber 152 is connected to the circulation pump 500 through a pump inlet channel 170. Note that reference sign 170a in FIG. 4 denotes an inlet port of the pump inlet channel 170.

Next, the flow of the ink inside the liquid ejection head 1 having the above configuration will be described. As illustrated in FIG. 5, the ink stored in the ink tank 2 is pressurized by the external pump 21 provided in the liquid ejection apparatus 50 to thereby become an ink flow at a positive pressure and is supplied to the circulation unit 54 of the liquid ejection head 1.

The ink supplied to the circulation unit 54 passes through the filter 110, so that foreign substances such as dust and bubbles are removed. The ink then flows into the first valve chamber 121 provided in the first pressure adjustment unit 120. The pressure on the ink drops due to the pressure loss by the passage through the filter 110, but the pressure on the ink is still positive at this point. Thereafter, in a case where the valve 190A is open, the ink having flowed into the first valve chamber 121 passes through the communication port 191A and flows into the first pressure control chamber 122. Due to the pressure loss by the passage through the communication port 191A, the pressure on the ink having flowed into the first pressure control chamber 122 switches from the positive pressure to a negative pressure.

Next, the flow of the ink in the circulation path will be described. The circulation pump 500 operates so as to send the ink which the pump has sucked in from the pump inlet channel 170 located upstream of the pump to the pump outlet channel 180 located downstream of the pump. Thus, as the pump is driven, the ink supplied to the first pressure control chamber 122 flows into the supply channel 130 and the bypass channel 160 along with the ink sent from the pump outlet channel 180. In the present embodiment, while details will be described later, a piezoelectric diaphragm pump using a piezoelectric element attached to a diaphragm as a driving source is used as the circulation pump 500 capable of sending the liquid. The piezoelectric diaphragm pump is a pump that sends a liquid by inputting a driving voltage to a piezoelectric element to change the volume of a pump chamber and causing two check valves to alternatively move with the change in pressure.

The ink having flowed into the supply channel 130 flows into the pressure chambers 12 from the ink supply port in the ejection module 300 through the common supply channel 18. Part of that ink is ejected from the ejection ports 68 as the ejection elements 15 are driven (generate heat). Also, the remaining ink not used in the ejection flows through the pressure chambers 12 and passes through the common collection channel 19. Thereafter, the ink flows into the collection channel 140 connected to the ejection module 300. The ink having flowed into the collection channel 140 flows into the second pressure control chamber 152 of the second pressure adjustment unit 150.

On the other hand, the ink having flowed into the bypass channel 160 from the first pressure control chamber 122 flows into the second valve chamber 151 and then passes through the communication port 191B to flow into the second pressure control chamber 152. The ink having flowed into the second pressure control chamber 152 through the bypass channel 160 and the ink collected from the collection channel 140 are sucked into the circulation pump 500 through the pump inlet channel 170 as the circulation pump 500 is driven. Then, the inks sucked into the circulation pump 500 are sent to the pump outlet channel 180 and flow into the first pressure control chamber 122 again. Thereafter, the ink flowing into the second pressure control chamber 152 from the first pressure control chamber 122 through the supply channel 130 and the ejection module 300 and the ink flowing into the second pressure control chamber 152 through the bypass channel 160 will flow into the circulation pump 500. The inks are then sent from the circulation pump 500 to the first pressure control chamber 122. The ink circulation is performed within the circulation path in this manner.

As described above, in the present embodiment, the liquids can be circulated through the respective circulation paths formed in the liquid ejection head 1 with the respective circulation pumps 500. This makes it possible to suppress thickening of the inks and deposition of precipitating components of the inks of the color materials inside the ejection modules 300. Accordingly, the fluidity of the inks in the ejection modules 300 and ejection characteristics at the ejection ports 68 can be maintained well.

Also, the circulation paths in the present embodiment employ a configuration that is complete between the liquid ejection head 1 and the circulation units 54 mounted on the carriage 60 together. Thus, the circulation path lengths are significantly shorter than those in a case where the inks are circulated between the ink tanks 2, which are provided outside the carriage 60, and the liquid ejection head 1. This makes it possible to circulate the inks with small circulation pumps, such as piezoelectric pumps.

Moreover, the configuration is such that only channels for supplying the inks (ink supply tubes 59) are included as channels that connect the liquid ejection head 1 and the ink tanks 2. In other words, a configuration that does not require channels for collecting the inks from the liquid ejection head 1 into the ink tanks 2 is employed. Accordingly, only ink supply tubes need to be provided to connect the ink tanks 2 and the liquid ejection head 1, and no ink collection tube needs to be provided. The inside of the liquid ejection apparatus 50 therefore has a simpler configuration with less tubes. This can downsize the entire apparatus. Moreover, the reduction in the number of tubes reduces the fluctuations in ink pressure due to the swinging of the tubes caused by main scanning of the liquid ejection head 1.

Also, the swinging of the tubes during main scanning of the liquid ejection head 1 imposes a driving load on a carriage motor driving the carriage 60. Hence, the reduction of the number of tubes reduces the driving load of the carriage motor, which makes it possible to simplify the main scanning mechanism including the carriage motor and the like. Moreover, since the inks do not need to be collected into the ink tanks 2 from the liquid ejection head 1, the external pumps 21 can be downsized as well. Thus, according to the present embodiment, it is possible to configure the liquid ejection apparatus 50 such that the liquids can be circulated therein while also reducing the size and cost of the liquid ejection apparatus 50.

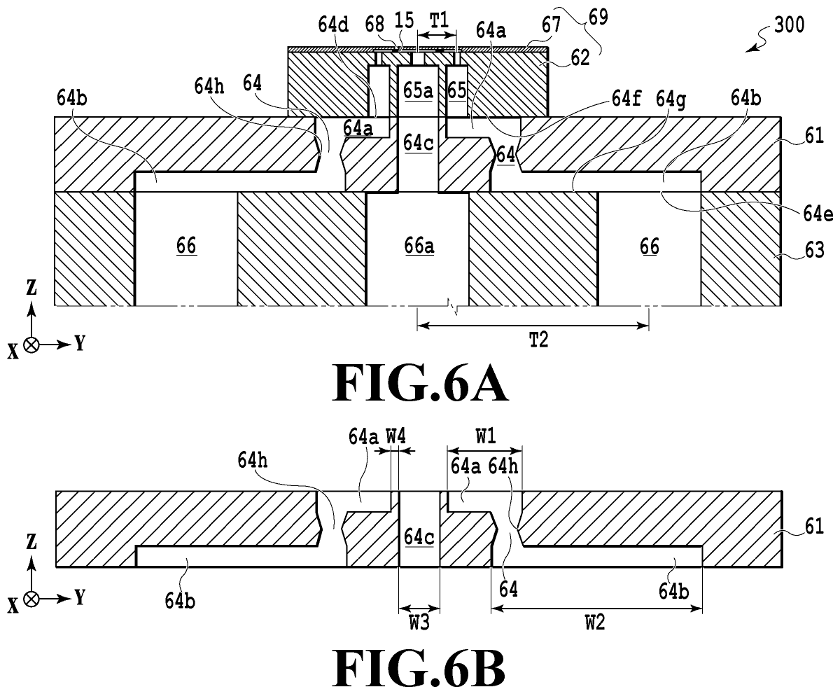

FIG. 6A is a cross-sectional view taken along the VI-VI line in FIG. 2B, and FIG. 6B is a cross-sectional view illustrating a silicon channel member 61 in FIG. 6A. Each ejection module 300 is formed by laminating an ejection substrate 69 having ejection elements, the channel member 61 made of silicon, and a resin channel member 63 made of a resin. The ejection substrate 69 is formed by laminating an ejection port forming member 67 (see FIG. 4) and a substrate 62 made of silicon (hereinafter referred to simply as the silicon substrate 62).

In the ejection port forming member 67, there are formed multiple ejection ports 68 and multiple pressure chambers 12 (see FIG. 4) communicating with the respective ejection ports 68. At positions on the silicon substrate 62 corresponding to the pressure chambers 12, there are provided ejection elements 15 for ejecting the ink from the corresponding ejection ports 68. Also, electric wirings not illustrated for supplying electric power and ejection signals to the ejection elements 15 are formed in the silicon substrate 62. Moreover, supply paths 65 shared by the pressure chambers 12 for supplying the ink thereto and a collection path 65a shared by the pressure chambers 12 for collecting the ink therefrom are formed in the silicon substrate 62. The supply paths 65 and the collection path 65a are formed in the silicon substrate 62 from the surface opposite to the surface on which the ejection port forming member 67 is laminated.

The configuration is such that the ejection port forming member 67 with the pressure chambers 12 formed therein is provided on the silicon substrate 62, and the pressure chambers 12 receive pressures generated by the ejection elements 15. Also, in the ejection port forming member 67, the ejection elements 15 and the ejection ports 68 are provided at opposed positions. In this way, film boiling occurs in the liquid as it is heated by the ejection elements 15, and the pressure resulting from the film boiling enables the liquid to be ejected from the ejection ports 68. By forming the ejection port forming member 67 on the silicon substrate 62, the pressure chambers 12 (see FIG. 4) communicate with the supply paths 65 in the silicon substrate 62, so that the liquid supplied from the supply paths 65 will flow into the pressure chambers 12.

The ejection substrate 69 is bonded to the channel member 61 with an adhesive agent such that the supply paths 65 in the silicon substrate 62 and channels 64 in the channel member 61 communicate with each other and the collection path 65a in the silicon substrate 62 and a channel 64c in the channel member 61 communicate with each other. In the present embodiment, each channel in the channel member 61 is formed by anisotropic wet etching. Details of the method of forming the channel member 61 will be described later. The supply paths 65 are capable of supplying the liquid to the pressure chambers 12 and the ejection ports 68. The liquid having flowed through the channels 64 enters the pressure chambers 12 through the supply paths 65 and is ejected from the ejection ports 68 by actions of the ejection elements 15. The two channels 64 are provided to be line symmetric about the channel 64c.

Expanding portions 64a are formed at the portions of the channels 64 in the channel member 61 to be connected to the supply paths 65 in the ejection substrate 69. At each expanding portion 64a, an opening portion 64d of the channel 64 to be connected to the corresponding supply path 65 is expanded in the Y direction or the −Y direction (a direction crossing the array direction of the ejection port arrays 4 (the X direction in FIGS. 6A and 6B). The opening portion 64d of the expanding portion 64a has a larger opening than the opening of the supply path 65. Specifically, each expanding portion 64a is provided so as to expand from a penetrating portion 64h, which penetrates through the channel member 61 in the Z direction, toward an inner side of the channel member 61 (a direction toward the channel 64c for collection). The expanding portion 64a is provided by forming a recess in the −Z direction from the opening portion 64d. More specifically, the expanding portion 64a includes a space having a predetermined depth in the −Z direction from the opening portion 64d. In a plan view of the ejection module 300 along the Z direction, the opening portion 64d has an opening area that is at least twice larger than the opening area of the opening of the supply path 65.

The resin channel member 63 as a support member for the ejection substrate 69 and the channel member 61 is a resin member formed by injection molding, and is molded by pouring a resin into a mold. The channel member 61 and the resin channel member 63 are bonded by an adhesive agent.

Expanding portions 64b are formed at the portions of the channels 64 in the channel member 61 to be connected to resin supply paths (support member supply paths) 66 in the resin channel member 63. At each expanding portion 64b, an opening portion 64e of the channel 64 to be connected to the corresponding resin supply path 66 is expanded in the Y direction or the −Y direction. The opening portion 64e of the expanding portion 64b has a larger opening than the opening of the resin supply path 66 (support member supply port). Specifically, each expanding portion 64b is provided so as to expand from the corresponding penetrating portion 64h toward an outer side of the channel member 61 (a direction away from the channel 64c for collection). The expanding portion 64b is provided by forming a recess in the Z direction from the opening portion 64e. More specifically, the expanding portion 64b includes a space having a predetermined depth in the Z direction (ejection direction) from the opening portion 64e. The resin channel member 63 includes a resin collection path (support member collection path) 66a between the two resin supply paths 66.

It is desirable that a width W2 of the expanding portions 64b in the Y direction is at least twice larger than a width W1 of the expanding portions 64a in the Y direction, as illustrated in FIG. 6B. The size of the recesses (depths) of the expanding portions 64a in the −Z direction and the size of the recesses (depths) of the expanding portions 64b in the Z direction are desirably about equal to the width of the penetrating portions 64h of the channels 64 in the Y direction. A width W3 of the channel 64c in the Y direction is desirably equal to the width of the collection path 65a in the center of the silicon substrate 62 in the Y direction. A width W4 of the wall between each expanding portion 64a and the channel 64c is desirably substantially equal to the width of the wall between each supply path 65 and the collection path 65a in the silicon substrate 62.

In the ejection substrate 69 in the present embodiment, the distance between the centers of each supply path 65 and the collection path 65a in the Y direction is 0.6 mm or less. In the present embodiment, the channels 64 and the collection path 64c can be formed at pitches corresponding to the narrow pitches between the supply paths 65 and the collection path 65a by forming the channels 64 including the expanding portions 64a and 64b in the channel member 61 by anisotropic wet etching. Since the channels 64 and the collection path 64c can be formed at pitches corresponding to the narrow pitches between the supply paths 65 and the collection path 65a, the distances between the supply paths 65 and the collection path 64c can be short, thereby allowing efficient circulation of the liquid inside the liquid ejection head 1. By employing anisotropic wet etching, relatively complicated channels whose widths and directions change at intermediate portions as in the present embodiment can be formed in a single silicon member.

Hence, the channel member 61 can be manufactured inexpensively as compared to a configuration in which complicated channels are formed by laminating multiple substrates in which different channels are formed. That is, a channel member having a relatively complicated channel shape is interposed between the resin channel member 63, in which the resin supply paths 66 and the resin collection path 66a are arrayed at wider pitches, and the silicon substrate 62, in which the supply paths 65 and the collection path 65a are arrayed at narrower pitches. As a result, the difference between these pitches is adjusted.

Also, the predetermined depth of the expanding portions 64a in the −Z direction and the predetermined depth of the expanding portions 64b in the Z direction are desirably equal. The expanding portions 64a are desirably formed partly by a surface 64f extending along the surface of the silicon substrate 62 to be bonded to of the channel member 61. This surface 64f is more desirably a surface substantially parallel to the bonding surface. The expanding portions 64b are desirably formed partly by a surface 64g extending along the surface of the resin channel member 63 to be boned to the channel member 61. This surface 64g is more desirably a surface substantially parallel to the bonding surface.

Providing the expanding portions 64a and 64b in the channel member 61 as described above enables channels to be reliably formed between the silicon substrate 62 and the resin channel member 63 even through a pitch T1 between each supply paths 65 and the collection path 65a is narrower than a pitch T2 between the corresponding resin supply path 66 and the resin collection path 66a. Moreover, providing the expanding portions 64a and 64b enables the supply paths 65 the resin supply paths 66 to communicate with each other without having to narrow the distances between the penetrating portions of the channels 64 and the channel 64c in the channel member 61.

The channels 64 including the expanding portions 64a and 64b are provided so as to extend in the X direction along the ejection port arrays 4 (see FIG. 2B). A single channel 64 including the expanding portions 64a and 64b may be provided per supply path 65, or multiple channels 64 each including the expanding portions 64a and 64b may be provided per supply path 65.

A process of manufacturing the channel member 61 will now be described below in the order of steps through a specific example.

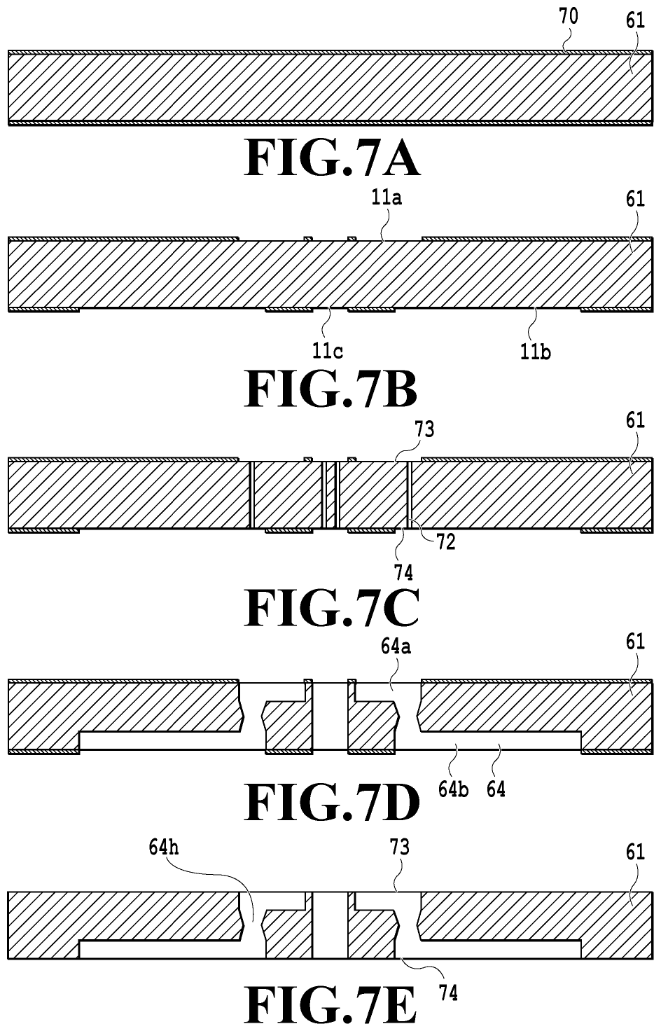

FIGS. 7A to 7F are views illustrating the process of manufacturing the channel member 61 in the order of steps. First, in the manufacturing of the channel member 61, a mask material 70, such as a thermal oxide film which will serve as a patterning mask for preventing damage from immersion in a strong alkaline etchant is formed on the front and back surfaces of the channel member 61, which is made of silicon, as illustrated in FIG. 7A. Then, as illustrated in FIG. 7B, opening portions (11a, 11b, and 11c) are provided in the mask material 70 (opening portion forming step). For this, patterning for forming expanding portions 4a (11a) on the front side of the substrate and expanding portions 4b (11b) on the back side of the substrate is performed. The opening portions 11a on the front side and the opening portions 11b on the back side are patterned so as to partly overlap each other (have overlapping regions) on the front and back sides in a plan view along the Z direction. The opening portions 11a and the opening portions 11b have opening widths larger than the widths of the respective supply ports to which they are to be connected (65 and 66).

Then, as illustrated in FIG. 7C, through-holes 72 are formed through the channel member 61 with a YAG laser or the like, for example. As for the portions to penetrate through in this step, each of the opening portions 11a and 11b is provided with one through-hole 72 formed therethrough, and the opening portion 11c is provided with two through-holes 72 formed therethrough (through-hole forming step). The number of holes to be formed by the laser processing may be changed according to the width of the penetrating portion to be formed. Each through-hole 72 is formed by applying 220 pulses (applying a laser beam 220 times), for example.

Then, as illustrated in FIG. 7D, the channel member 61 in which the through-holes 72 are formed is subjected to anisotropic wet etching by immersing it in an aqueous tetramethylammonium hydroxide (TMAH) solution (concentration=22%) at a temperature of 83° C. for 2 to 3 hours. The liquid contacts the channel member 61 through the opening portions 11a and the opening portions 11b and enters penetrating portions 72 from the front and back surfaces. As a result, penetrating channels (penetrating paths) 64 including the expanding portions 64a and the expanding portions 64b are formed (penetrating path forming step). The sizes of the recesses of the expanding portions 64a and the expanding portions 64b and the widths of the penetrating portions can be adjusted by changing the duration of the immersion. Then, as illustrated in FIG. 7E, the mask material (mask layer) 70, which is no longer necessary, is partly removed by immersing it in a dedicated removing solution for a predetermined time.

The silicon as the channel member 61 in the present embodiment is a silicon substrate whose crystal plane is (110). In this case, the side surfaces of the penetrating portions 64h of the penetrating portions 64 formed by the etching are desirably formed at an angle of 60° to 100°, inclusive, to a first surface 73 and a second surface 74 of the channel member 61. The side surfaces are more desirably formed at an angle of 70° to 95°, inclusive, to the first surface 73 and the second surface 74.

The channel member 61 made of a silicon material in which expanding portions are provided by such a process is used to form appropriate communication paths between the resin channel member 63, in which multiple changes are arrayed at wide pitches, and the silicon substrate 62, in which multiple channels are arrayed at narrow pitches. In this way, the liquid can be supplied and collected in a suitable manner.

### Other Embodiments

In the above embodiment, an example in which the ejection module 300 includes a collection path has been described. However, the configuration is not limited to this and may only include supply paths and no collection path.

Also, in the above embodiment, an example in which each circulation unit 54 is mounted on the carriage 60 has been described. However, the configuration is not limited to this and may include a circulation path outside the carriage 60.

Nonetheless, the present disclosure can be suitable used in a liquid ejection head 1 including the circulation units 54 and having liquid circulation paths formed on the carriage 60 as in the above embodiment. The configuration having liquid circulation paths on the carriage 60 is advantageous in that the circulation path length is short, making it easy to circulate the liquids even with low flow-rate circulation units. However, as compared to a case where the circulation path length is long, the liquids easily thicken and solidify, and it is therefore desirable to make the channels' openings large. Thus, the channel member 61 as in the above embodiment can be suitably used in a liquid ejection head with liquid circulation paths formed on a carriage.

Also, in the above embodiment, a serial inkjet printing apparatus which causes the liquid ejection head 1 to move while performing an ejection operation to perform printing on a print medium P has been described as an example. Alternatively, the liquid ejection apparatus may be of a line type which conveys a print medium to a fixed liquid ejection head to perform printing.

As described above, the channels 64 formed in the channel member 61 and including the expanding portions 64a and 64b connect the supply paths 65 in the silicon substrate 62 and the resin supply paths 66 in the resin channel member 63 to each other. This makes it possible to provide a liquid ejection head which is inexpensive and capable of using an element substrate with narrow pitches between supply ports, a liquid ejection apparatus, and a method of manufacturing a liquid ejection head.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-004720, filed Jan. 16, 2024, which is hereby incorporated by reference wherein in its entirety.

What is claimed is:

1. A liquid ejection head comprising:
an ejection substrate including a first ejection port array being a plurality of ejection ports for ejecting a liquid arranged in an array, and a first supply path for supplying the liquid to the first ejection port array;
a channel member including a first channel that communicates with the first supply path in a case where the channel member is laminated on the ejection substrate; and
a support member including a first support member supply path that communicates with the first channel in a case where the support member is laminated on a second surface of the channel member on an opposite side from a first surface thereof on which the ejection substrate is laminated, wherein
the first channel has
a first penetrating portion penetrating through the channel member in a direction of the lamination,
a first expanding portion partly facing a first opening of the first supply path, having a depth in the direction of the lamination, and extending in a first direction from a position opposed to the first opening to the first penetrating portion, the first direction crossing the direction of the lamination, and
a second expanding portion partly facing a second opening of the first support member supply path, having a depth in the direction of the lamination, and extending in the first direction from the first penetrating portion to the second opening so as to have an opening area larger than an opening area of the first expanding portion.

2. The liquid ejection head according to claim 1, wherein
the ejection substrate further includes a second ejection port array being a plurality of ejection ports for ejecting the liquid arranged in an array, and a second supply path for supplying the liquid to the second ejection port array,
the channel member further includes a second channel that communicates with the second supply path in a case where the channel member is laminated on the ejection substrate,
the support member further includes a second support member supply path that communicates with the second channel in a case where the support member is laminated on the second surface of the channel member, and
the second channel has
a second penetrating portion penetrating through the channel member in the direction of the lamination,
a third expanding portion partly facing a third opening of the second supply path, having a depth in the direction of the lamination, and extending in a second direction from a position opposed to the third opening to the second penetrating portion, the second direction being a direction opposite to the first direction, and
a fourth expanding portion partly facing a fourth opening of the second support member supply path, having a depth in the direction of the lamination, and extending in the second direction from the second penetrating portion to the fourth opening so as to have an opening area larger than an opening area of the third expanding portion.

3. The liquid ejection head according to claim 2, wherein a distance between the first supply path and the second supply path in the ejection substrate in the first direction is smaller than a distance between the first support member supply path and the second support member supply path in the support member in the first direction.

4. The liquid ejection head according to claim 2, wherein
the ejection substrate further includes a collection path communicating with the ejection port, and
the channel member further includes a third channel connected to the collection path.

5. The liquid ejection head according to claim 4, wherein the collection path is present between the first supply path and the second supply path in the first direction.

6. The liquid ejection head according to claim 5, wherein the first channel and the second channel are provided to be line symmetric about the third channel.

7. The liquid ejection head according to claim 2, wherein the first penetrating portion and the second penetrating portion include side surfaces at an angle of 60° to 100°, inclusive, to the first surface and the second surface.

8. The liquid ejection head according to claim 7, wherein the first penetrating portion and the second penetrating portion include side surfaces at an angle of 70° to 95°, inclusive, to the first surface and the second surface.

9. The liquid ejection head according to claim 1, wherein the first expanding portion has an opening area that is at least twice larger than an opening area of the first opening in a plan view of the channel member from the direction of the lamination.

10. The liquid ejection head according to claim 1, wherein the first expanding portion and the second expanding portion partly overlap each other in a plan view of the channel member from the direction of the lamination.

11. The liquid ejection head according to claim 10, wherein a portion at which the first expanding portion and the second expanding portion overlap each other in the plan view of the channel member from the direction of the lamination is the first penetrating portion.

12. The liquid ejection head according to claim 4, wherein a distance between centers of the first supply path and the collection path in the first direction is 0.6 mm or less.

13. The liquid ejection head according to claim 4, wherein the support member includes a support member collection path communicating with the ejection ports between the first support member supply path and the second support member supply path.

14. The liquid ejection head according to claim 4, further comprising a circulation unit that circulates the liquid by supplying the liquid collected from the collection path to the first supply path and the second supply path, wherein
the liquid ejection head is mountable on a carriage of a liquid ejection apparatus.

15. The liquid ejection head according to claim 1, wherein the channel member is silicon.

16. A liquid ejection apparatus comprising:
the liquid ejection head according to claim 1;
a circulation unit that circulates the liquid inside the liquid ejection head;
a carriage that carries the liquid ejection head and the circulation unit and moves along with an ejection operation of the liquid ejection head; and
a conveyance unit that conveys a print medium, wherein
the liquid ejection apparatus causes the liquid ejection head to eject the liquid onto the print medium.

17. A method of manufacturing a liquid ejection head comprising:
forming a mask layer on a first surface and a second surface of a silicon substrate, the second surface being a surface on an opposite side from the first surface;
forming a first opening portion by partly removing the mask layer on the first surface and forming a second opening portion by partly removing the mask layer on the second surface;
forming a through-hole penetrating through the silicon substrate from the first opening portion to the second opening portion;
forming a penetrating path penetrating from the first opening portion to the second opening portion by immersing the silicon substrate in which the through-hole is formed in an etchant;
removing the mask layer from the first surface and the second surface after forming a penetrating path;
laminating an ejection substrate in which a plurality of ejection ports for ejecting a liquid and a supply path for supplying the liquid to the ejection ports are formed on the first surface such that the penetrating path and the supply path communicate with each other; and
laminating a support member in which a channel for supplying the liquid to the ejection port is formed on the second surface such that the penetrating path and the channel communicate with each other, wherein
in the forming a first opening portion and a second opening portion, the first opening portion and the second opening portion are formed such that, in a plan view of the silicon substrate in a direction of the lamination, the first opening portion includes an overlapping region overlapping the second opening portion and a region extending to an inner side of the silicon substrate from the overlapping region, and the second opening portion includes the overlapping region and a region extending to an outer side of the silicon substrate from the overlapping region.

18. The method of manufacturing a liquid ejection head according to claim 17, wherein the forming a penetrating path includes performing wet etching on the silicon substrate having a crystal plane (110) on the first surface.

19. The method of manufacturing a liquid ejection head according to claim 18, wherein in the forming a penetrating path, the penetrating path is formed at an angle of 60° to 100°, inclusive, to the first surface and the second surface.

20. The method of manufacturing a liquid ejection head according to claim 19, wherein in the forming a penetrating path, the penetrating path is formed at an angle of 70° to 95°, inclusive, to the first surface and the second surface.
